(19) United States
(12) Patent Application Publication
(10) Pub. No.: US 2015/0178825 A1
(43) Pub. Date: Jun. 25, 2015

(54) Methods and Apparatus for Quantitative Assessment of Behavior in Financial Entities and Transactions

(71) Applicant: Citibank, N.A., New York, NY (US)

(72) Inventors: Juan Huerta, Pleasantville, NY (US); Yulin Ning, Manhasset, NY (US); Leandro Dalle Mule, Darien, CT (US)

(21) Appl. No.: 14/138,194

(22) Filed: Dec. 23, 2013

(51) Int. Cl. G06Q 40/00

(52) U.S. Cl. CPC G06Q 40/00

(57) ABSTRACT

Methods and apparatus for assessing behavior, such as fraud and risk, in financial entities and transactions involve, for example, receiving, using a processing engine computer having a processor coupled to memory, data related to a plurality of entities. The plurality of entities is segmented into a plurality of entity peer groups based at least in part on a plurality of behavior components identified for each entity in the received data. For each entity, a behavior norm is created based on the entity history and its relationship to its corresponding peer group. All of the behavior components for each of the entities are normalized, and aggregated and a behavior score generated for each entity based on a continuous comparison of behavior values of each entity to a behavior norm for the entity peer group into which the entity is segmented. Based on new data received from time-to-time, this apparatus dynamically adapts the plurality of entities which may be re-segmented, the behavior components may be re-normalized, and a new behavior score may be generated for each entity.

### FIELD OF THE INVENTION

The present invention relates generally to the field of behavior assessment, such as fraud and risk assessment, in financial entities and transactions, and more particularly to methods and apparatus for data-adaptive, highly-scalable quantitative assessment of behavior, such as fraud and risk, in financial entities and transactions.

### BACKGROUND OF THE INVENTION

Currently available risk and fraud detection systems include both commercially available and custom solutions. Commercial systems, such as NICE-ACTIMIZE® and FICO-FALCON®, focus on producing fraud risk assessment for transactions, particularly credit card transaction and point of sale debit transaction authorization. Such systems are typically rule-based “black box” systems. Custom solutions comprise one-of-a-kind types of solutions that focus, for example, on communication protocols, policy transmission protocols, and specific approaches to creating rules or policies.

These currently available commercial and custom methods and approaches are generally based on predefined and pre-enumerated static rule sets. Thus, they are unable to adjust and adapt to dynamically changing data sets as well as unobserved fraud prevention patterns. Further, such current methods and approaches are not scalable in terms of their ability to handle arbitrarily large sets of data and information.

There is a present need for methods and systems for data-adaptive, highly-scalable quantitative assessment of fraud and risk in financial entities and transactions that overcome the data scalability and flexibility limitations of currently available systems, for example, by providing a mechanism to integrate information and scores generated from different and changing data and normalizing such information in order to produce normalized scores of peer and self dissimilarity and unpredictability that reflect potential existence of fraud incidents as well as abnormal levels of risk.

### SUMMARY OF THE INVENTION

Embodiments of the invention employ computer hardware and software, including, without limitation, one or more processors coupled to memory and non-transitory, computer-readable storage media with one or more executable computer application programs stored thereon which instruct the processors to perform the quantitative behavior assessment in financial entities and transactions described herein. Such methods and systems may involve, for example, receiving, using a processing engine computer having a processor coupled to memory, data related to a plurality of entities; segmenting, using the processing engine computer, the plurality of entities into a plurality of entity peer groups based at least in part on a plurality of behavior components identified for each entity in the received data; normalizing, using the processing engine computer, each of the behavior components for each of the entity peer groups; and generating, using the processing engine computer, a behavior score for each entity based on a comparison of behavior values of each entity to a behavior norm for the entity peer group into which the entity is segmented.

In aspects of embodiments of the invention, the plurality of entities may comprise, for example, financial entities, financial products, or financial transactions. In other aspects, the plurality of behavior components identified for each entity in the received data may comprise, for example, at least one of abnormal transaction behavior and observed losses identified in the data. In further aspects, segmenting the plurality of entities may involve, for example, determining underlying clustering of entities based at least in part upon transaction patterns identified in the data. In additional aspects, segmenting the plurality of entities may involve, for example, creating transaction features identified in the data at an account level for each entity.

In further aspects of embodiments of the invention, creating transaction features at an account level may involve, for example, creating transaction features at an account level based at least in part on transaction types, transaction amounts, transaction frequency, and transaction times identified in the data. In still further aspects, creating transaction features may involve, for example, aggregating transaction features for each entity based at least in part on feature frequencies identified in the data. In other aspects, creating transaction features may involve, for example, representing the transaction features by numeric values. In additional aspects, representing the transaction features by numeric values may involve, for example, generating vectors for each entity based at lest in part on said numeric values. In further aspects, generating the vectors for each entity may involve, for example, integrating text mining with clustering to establish the transaction features through feature creation and vectorization.

In additional aspects of embodiments of the invention, creating transaction features at an account level may involve, for example, aggregating the transaction features into an entity level for each entity. In further aspects, segmenting the plurality of entities into a plurality of entity peer groups may involve, for example, segmenting the plurality of entities into the plurality of entity peer groups based at least in part on loss characteristics identified in the data. In other aspects segmenting the plurality of entities into the plurality of entity peer groups based on loss characteristics, may involve, for example, generating a predicted error that reflects outlier behaviors of at least one entity against the entity's peer group. In additional aspects, segmenting the plurality of entities into a plurality of entity peer groups may involve, for example, determining optimal peer group segments using multivariate regression decision tree analysis.

In still other aspects of embodiments of the invention, normalizing each of the behavior components may involve, for example, normalizing the behavior components using zero mean and covariance normalization by peer group. In further aspects, normalizing each of the behavior components may involve, for example, normalizing, aggregating and summing a plurality of different attribute sets having different scales. In still other aspects, normalizing each of the behavior components may involve employing multivariate normalization to account for multi-collinearity among different attribute sets.

In other aspects of embodiments of the invention, generating the behavior score may involve, for example, generating a quantitative behavior score that reflects an extent to which each entity presents behaviors consistent with operational risk or fraud. In additional aspects, generating the behavior score may involve, for example, comparing actual behaviors of each entity against the entity's expected behaviors and against behaviors of a segment norm for the entity's segment.

Further aspects of embodiments of the invention may involve, for example, receiving new data related to the plurality of subjects, re-segmenting the plurality of entities based at least in part on the plurality of behavior components identified in the new data, re-normalizing each of the behavior components, and generating a new behavior score for each entity. Still other aspects of embodiments of the invention may involve, for example, iteratively receiving new data related to the plurality of entities, iteratively re-segmenting the plurality of entities based at least in part a plurality of new behavior components identified in the new data, iteratively re-normalizing each of the behavior components, and iteratively generating a new behavior score for each entity.

These and other aspects of the invention will be set forth in part in the description which follows and in part will become more apparent to those skilled in the art upon examination of the following or may be learned from practice of the invention. It is intended that all such aspects are to be included within this description, are to be within the scope of the present invention, and are to be protected by the accompanying claims.

### BRIEF DESCRIPTION OF THE DRAWINGS

FIG. 1 is a schematic diagram that illustrates an overview example of key components and the flow of information between key components for embodiments of the invention;

FIG. 2 is a diagrammatic flow chart representation of an example of a process of generating a branch-at-risk score for embodiments of the invention;

FIG. 3 is a diagrammatic flow chart representation of an example of a process or methodology of the transaction time series pattern analysis model or T2spam for embodiments of the invention that may be employed to create a transaction pattern outlier score based on dissimilarity;

FIG. 4 is a diagrammatic flow chart representation of an example of the input data preparation process for the transaction time series pattern analysis model or T2spam for embodiments of the invention shown in FIG. 3;

FIG. 5 is a diagrammatic flow chart representation of an example of the T2Spam branch scoring process for embodiments of the invention;

FIG. 6 is a diagrammatic flow chart representation of an example of dynamic segmentation to create peer groups for embodiments of the invention;

FIG. 7 is a diagrammatic flow chart overview representation of an example of the methodology for normalization, distance calculation, and aggregation for embodiments of the invention;

FIG. 8 is a diagrammatic flow chart overview representation of an example of the dynamic nature of the process using re-evaluation and re-normalization for embodiments of the invention;

FIG. 9 is a diagrammatic flow chart representation of an example of the branch-at-risk outlier model mechanism and visualization of the modeling process and key components in the model for embodiments of the invention; and

FIG. 10 is a schematic flow chart that illustrates an overview example of the process of assessing fraud and risk in financial entities and transactions for embodiments of the invention.

### DETAILED DESCRIPTION

Reference will now be made in detail to embodiments of the invention, one or more examples of which are illustrated in the accompanying drawings. Each example is provided by way of explanation of the invention, not as a limitation of the invention. It will be apparent to those skilled in the art that various modifications and variations can be made in the present invention without departing from the scope or spirit of the invention. For example, features illustrated or described as part of one embodiment can be used in another embodiment to yield a still further embodiment. Thus, it is intended that the present invention cover such modifications and variations that come within the scope of the invention.

Embodiments of the invention may utilize one or more special purpose computer software application program processes, each of which is tangibly embodied in a physical storage device executable on one or more physical computer hardware machines, and each of which is executing on one or more of the physical computer hardware machines (each, a “computer program software application process”). Physical computer hardware machines employed in embodiments of the invention may comprise, for example, input/output devices, motherboards, processors, logic circuits, memory, data storage, hard drives, network connections, monitors, and power supplies. Such physical computer hardware machines may include, for example, user machines and server machines that may be coupled to one another via a network, such as a local area network, a wide area network, or a global network through telecommunications channels which may include wired or wireless devices and systems.

Embodiments of the invention overcome the data scalability and flexibility limitations of currently available systems. Thus, aspects of the invention provide a mechanism to integrate information and scores generating from different sources as well as changing sources. Other aspects of the invention normalize such information to produce normalized scores of peer and self-dissimilarity and unpredictability which reflect potential existence of fraud incidents as well as abnormal levels of risk.

Embodiments of the invention address the problem of generating a quantitative score which reflects the extent to which a financial entity such as a bank branch or a trading desk, a product such as a customer's account, or a transaction presents abnormal behaviors or properties that are consistent with increased operational risk or fraud. In the case of an entity or an account, embodiments of the invention may approach the problem of generating such quantity by focusing on a period of time. In the case of a transaction, embodiments of the invention may produce a score representing an instantaneous assessment. As used herein, “entity” may be deemed to include, without limitation, a financial entity, a branch bank, a trading desk, an account, or a transaction.

A significant question addressed by embodiments of the invention is how to include a consideration of a dynamic, changing, and arbitrarily large body of heterogeneous sources of data and information assessments of operational fraud and risk. Other aspects of the invention involve processing transaction data that may be also be used on applications beyond fraud and risk. Additional aspects of the invention involve a specific application of fraud and risk.

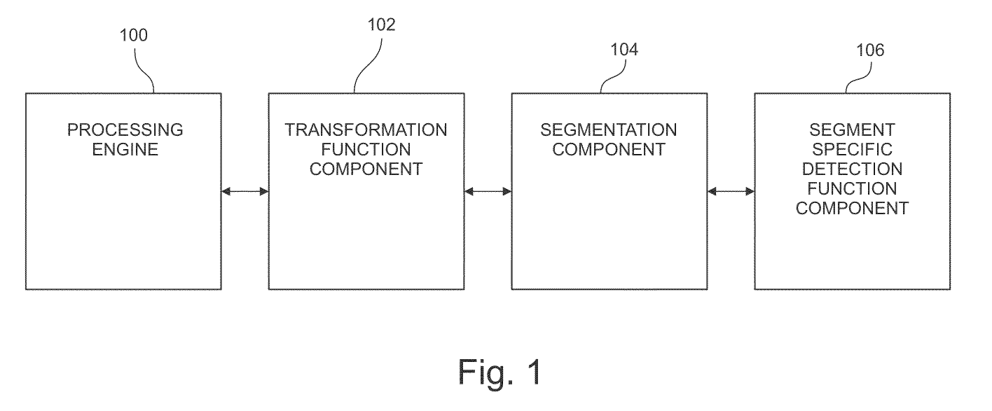

FIG. 1 is a schematic diagram that illustrates an overview example of key components and the flow of information between key components for embodiments of the invention. Referring to FIG. 1, such components may include, for example, a data processing engine 100 that is responsible for synthesizing compact projections of underlying data streams. Another such component may be, for example, a set of transformation functions 102 based on normalizing independent variables. Additional such components may include, for example, a segmentation component 104 and a segment specific outlier detection function 106 based on multidimensional standard errors of predictability functions.

According to embodiments of the invention, model parameters may be learned during training and applied during scoring to assess each entity or transaction. In addition, an optimal segmentation may be learned during model training. Also, predictability function parameters may be learned during model training, and independent variables may be selected or reduced. Further, multivariable segment specific statistics may also be learned during training.

During scoring for embodiments of the invention, an entity may be assessed against a segmentation to determine to which segment the entity belongs. In addition, raw data may be processed by the data processing engine 100, and compact data sets may be generated during scoring. Also during scoring, predictability functions may be applied using data, information and compact data to the segment specific function. Further, standard errors may be calculated, and relevant standard errors may be compared against segment-specific statistics to compute a final risk score.

Embodiments of the invention provide a dynamically changing risk scoring system that takes transaction information that is applicable to a particular customer and applies that transaction information over time to modify the risk-scoring algorithm. Embodiments of the invention may provide, for example, a branch-at-risk outlier model that employs a dynamic feature in the segmentation, normalization, and multi-dimensional risk aggregation of data into an entity risk score. In addition, embodiments of the invention may provide a specific methodology to each individual customer rather than applying a general rule to all customers. Further, the methodology for embodiments of the invention is dynamic over time, and thus updates itself as new transactions and new data are received by the system.

Embodiments of the invention provide a novel capability for an entity, such as a financial institution, to reduce fraud, threats and enterprise risk through the application of advanced outlier analytics to multiple data sources of the entity by employing a “big data” processing environment, such as Hadoop™. Thus, embodiments of the invention may leverage the “big data” infrastructure, such as “Hadoop™, to process billions of transactions efficiently and may be applied to many different areas as well as to different entities.

The model process for embodiments of the invention may be performed using, for example, many different programming languages, multiple processing platforms, a series of advanced analytic techniques and methods, as well as an overall approach that combines both supervised methods based on loss and non-supervised methods based on latent clustering. It is to be noted that embodiments of the invention are not limited to any particular number of programming languages and processing platforms and that any suitable number of either may be employed.

The approach and methodology associated with a branch-at-risk outlier model for embodiments of the invention address a fundamental question of how to take into consideration a dynamic, changing and arbitrarily large body of heterogeneous sources of data and information to create an adaptive outlier detection model. The branch-at-risk model provides a multidimensional approach using, for example, multiple different and dynamic risk components for outlier identification. Examples presented herein may employ, for example, nine such risk components. However, it is to be noted that embodiments of the invention are not limited to any particular number of such risk components, and any other suitable number of risk components may be utilized.

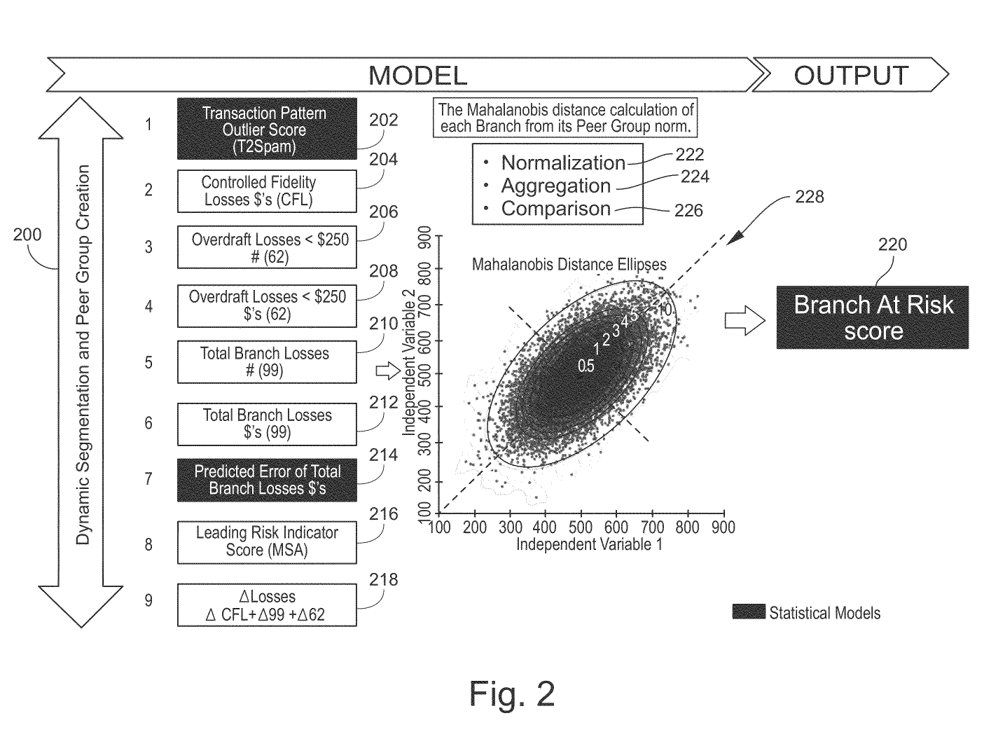

FIG. 2 is a diagrammatic flow chart representation of an example of a process of generating a branch-at-risk score for embodiments of the invention. As previously noted, an objective of the branch-at-risk model for embodiments of the invention may be to generate a quantitative score that reflects multi-dimensional operational risk or abnormal behaviors, for example, of a financial entity, such as a bank branch or a trading desk; a product, such as a customer's account; or a transaction. Achieving such an objective may serve to help an organization identify outliers and plan a focus for a review.

Referring to FIG. 2, a dynamic segmentation scheme 200 may initially be presented for a specific business purpose, and thereafter a peer group may be used as a basis for a benchmark. Within each segment, the model for embodiments of the invention may compare the actual behaviors of each branch against its expected behaviors and then against the behaviors of its segment norm. Components of risk may include, for example, abnormal transaction risk 202; observed losses, such as controllable fidelity losses 204, number of overdraft losses under $250 206, amount of overdraft losses under $250 208, total number of branch losses 210, and total amount of branch losses 212; predicted-error of total branch losses 214; Metropolitan Statistical Area (MSA) risk indicator 216; and deltas or changes of losses 218.

A branch-at-risk score 220 is a final outcome for the branch-at-risk model for embodiments of the invention. However, it is to be understood that the abnormal transaction risk component 202 from a transaction time series pattern analysis model, sometimes referred to herein as “T2spam”, may be employed as a standalone application that may be used to detect transaction abnormal behaviors. In generating a branch-at-risk score 220 for embodiments of the invention utilizing a “big data” processing environment, such as Hadoop™, billions of transactions may be processed at an account-level and their features may be aggregated into a branch level. In embodiments of the invention, all the risk components may be normalized 222, aggregated 224, and compared 226, using, for example, a Mahalanobis distance calculation 228 of each branch to its peer group norm to create the quantitative branch-at-risk score 220. The foregoing process is also dynamic, including dynamic segmentation and adapts to changed data sources and data inputs, as will be hereinafter described in greater detail.

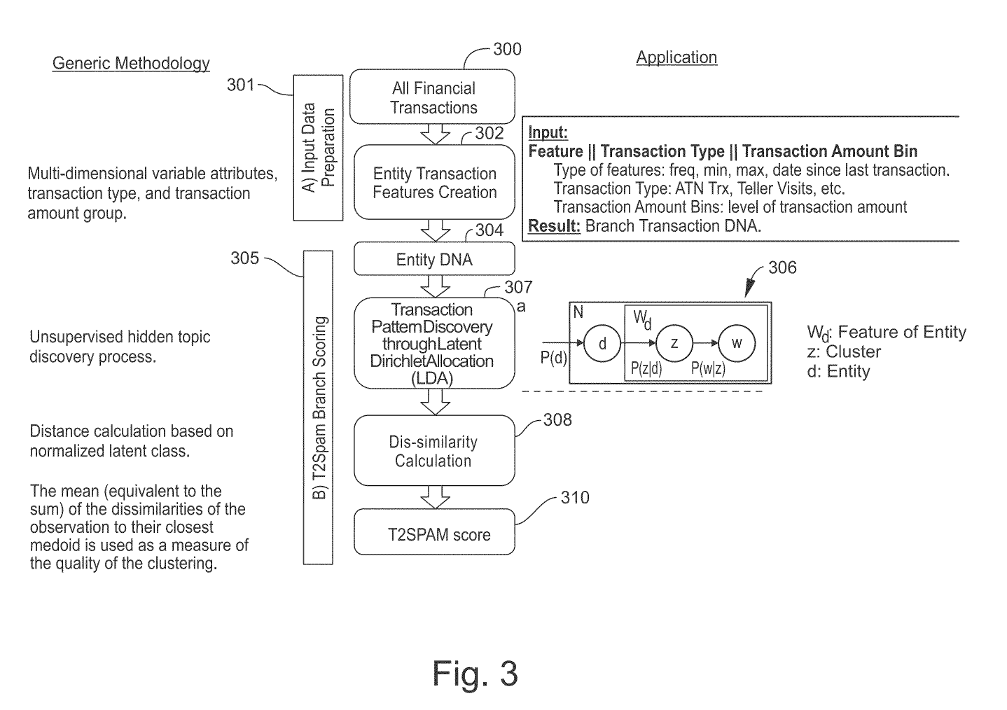

FIG. 3 is a diagrammatic flow chart representation of an example of a process or methodology of the transaction time series pattern analysis model or T2spam for embodiments of the invention that may be employed to create a transaction pattern outlier score 202 as shown in FIG. 2. The T2spam process for embodiments of the invention begins, for example, with all the financial transactions 300 associated with an entity. In the transaction time series pattern analysis model or T2spam methodology for embodiments of the invention, input data preparation 301 may involve initially dynamically creating transaction features 302 at an account level from an entity, such as a branch. Thereafter, the transaction features 302 may be used to create a branch level entity signature or “branch DNA” 304.

Entity transaction features 302 may be created at the account level using, for example, a combination of transaction types, such as ATM transactions and teller visits; transaction amounts; frequency of transactions; time dimensions; and various statistics of the transactions. Those entity transaction features 302 may then be aggregated into the entity or branch DNA 304 to reflect the transaction patterns at an entity level.

In the T2spam branch scoring process 305 for embodiments of the invention, a text mining approach, such as Latent Dirichlet Allocation (LDA), an example plate notation for which is shown at 306, is may be used for data mining to determine underlying clustering of branches based upon transaction patterns at 307. Within a cluster, a dissimilarity 308 between the particular branch and a center of the cluster may be evaluated to reflect abnormal patterns, and the output 310 may be used, for example as the input 202 for the branch-at-risk model for embodiments of the invention as shown in FIG. 2. As previously noted, the foregoing methodology may involve, for example, processing data for billions of transactions in a “big data” processing environment, such as the Hadoop™ environment.

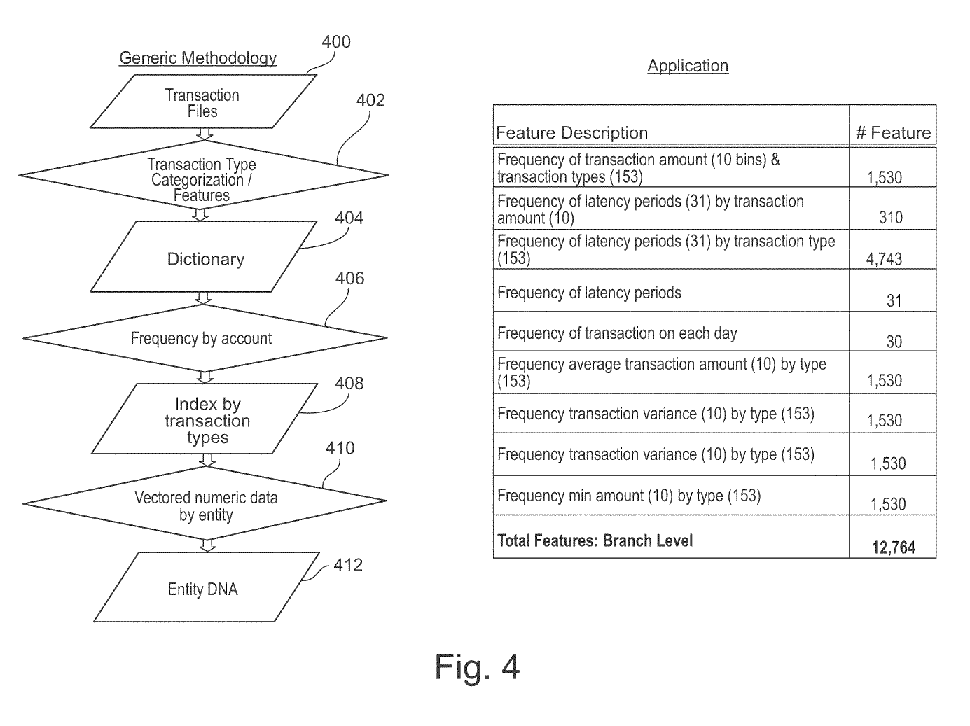

FIG. 4 is a diagrammatic flow chart representation of an example of the input data preparation process 301 for the transaction time series pattern analysis model or T2spam for embodiments of the invention shown in FIG. 3. In preparing the T2Spam input data, an entity feature may be created for each entity based on transaction features according to financial transaction records 400 that may number in the billions. The account-level features 402 that are created may reflect, for example, transaction type, transaction amount, transaction time, and various types of transaction-related statistics. Such account-level features 402 may be represented numerically and may number in the thousands. Referring to the example of FIG. 4, 12,000 or more such features 402 may be created. However, it is to be understood that the number of account-level features may be greater or smaller and that any suitable number such account-level features may be created for each entity.

Referring further to FIG. 4, a dictionary 404 may relate numerical values to features of particular transactions, accounts, or branches. Frequency by account 406 may provide, for example, a table for matching frequencies of features, such as frequencies of ATM withdrawals, to particular accounts. Index by transactions types 408 may provide, for example, a table for matching transaction types and features. Vectored numeric data by entity 410 may employ numeric values for features that reflect transaction behavior to generate vectors for entities such as branches. The entity DNA 412 may reflect all transaction behavior for an entity such as a particular branch.

As noted above, after creating the account-level features 402, such features may be aggregated into branch-level features to create a branch transaction DNA. Thereafter, the entity entries may be vectorized at 410 to create the entity DNA 412 as an input for the T2Spam model for embodiments of the invention. It is to be noted that the foregoing methodology may likewise involve, for example, processing data for billions of transactions in the “big data” processing environment, such as the Hadoop™ environment. It is to be further noted that the foregoing approach may also provide a generic approach for different applications involving many different kinds of transaction data.

In embodiments of the invention, the vectorization of the data from the branch features at 412 creates a scalability of processing which enables the handling of large-scale datasets. In the process of creating the account-level features 402, raw transaction data may be converted to structured transaction data. Further, transaction-level files may be converted to account-level files by account number, branch identification, transaction date, transaction type, and transaction amount. In addition, branch-level features may be generated including, for example, any number of transaction types, transaction amount bins, and different time periods, and any number of possible combinations for each account. Thus, in the example shown in FIG. 4, assuming 153 transaction types, 10 transaction amount bins, 31 different time periods, there may be over 12,000 possible combinations for each account. In generating branch-level features, the features may be aggregated by each branch based on feature frequencies.

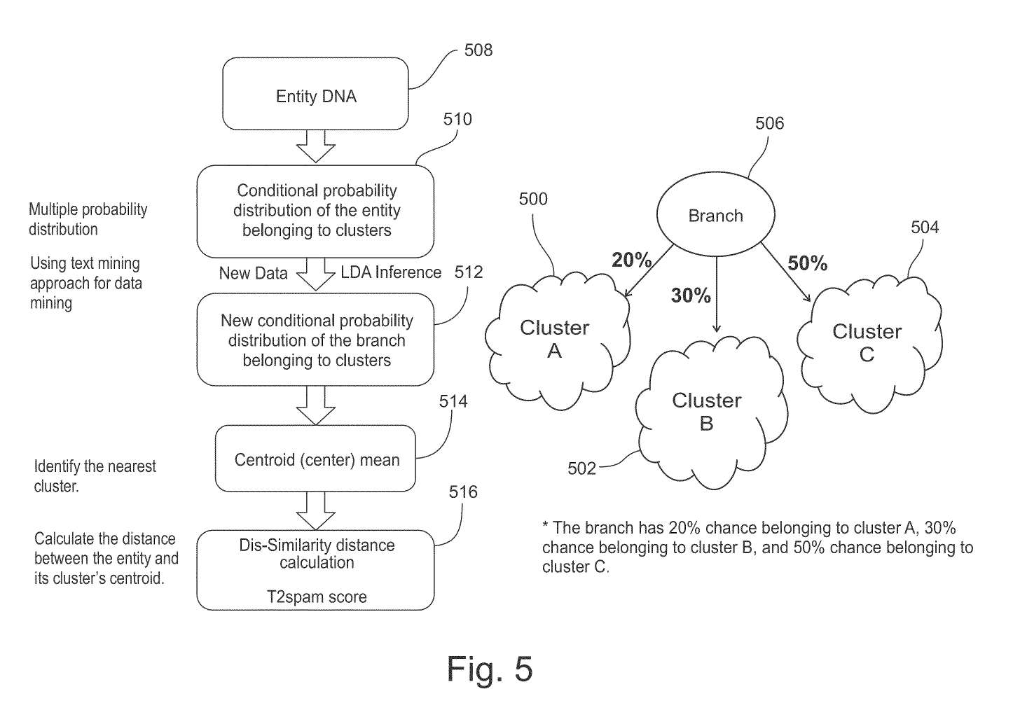

FIG. 5 is a diagrammatic flow chart representation of an example of the T2Spam branch scoring process for embodiments of the invention. The T2Spam model for embodiments of the invention may involve, for example, creating entity clusters, such as clusters A 500, B 502, and C 504, based on feature frequencies and distributions. In addition, each entity, such as a branch 506 may be assigned to a cluster based on its transaction feature patterns and scored based on its distance to the center of its assigned cluster.

Referring to FIG. 5, beginning with branch DNA at 508 a text mining approach, such as LDA, may be adopted to create branch transaction pattern clusters and conditional probabilities of a branch belonging to those clusters at 510. Thereafter, at 512, when new transaction data is received, new conditional probabilities of the branch belonging to those clusters may be created, the nearest cluster may be identified at 514, and the branch may be scored based on its distance to the center of its assigned cluster at 516.

It is to be understood that conditional probability distributions of the branch belonging to the clusters are produced rather than a simple positive or negative determination of whether a branch belongs to certain cluster. For example, as shown in FIG. 5, the particular branch may have a 20% chance of belonging to cluster A 500, a 30% chance of belonging to cluster B 502 and a 50% chance of belonging to cluster C 504. As noted above, at 516, the dissimilarities may be calculated to determine outlier behaviors for the branch. In the example of FIG. 5, the particular branch may be scored based on its distance to the center of its assigned cluster C 504, which is its nearest cluster.

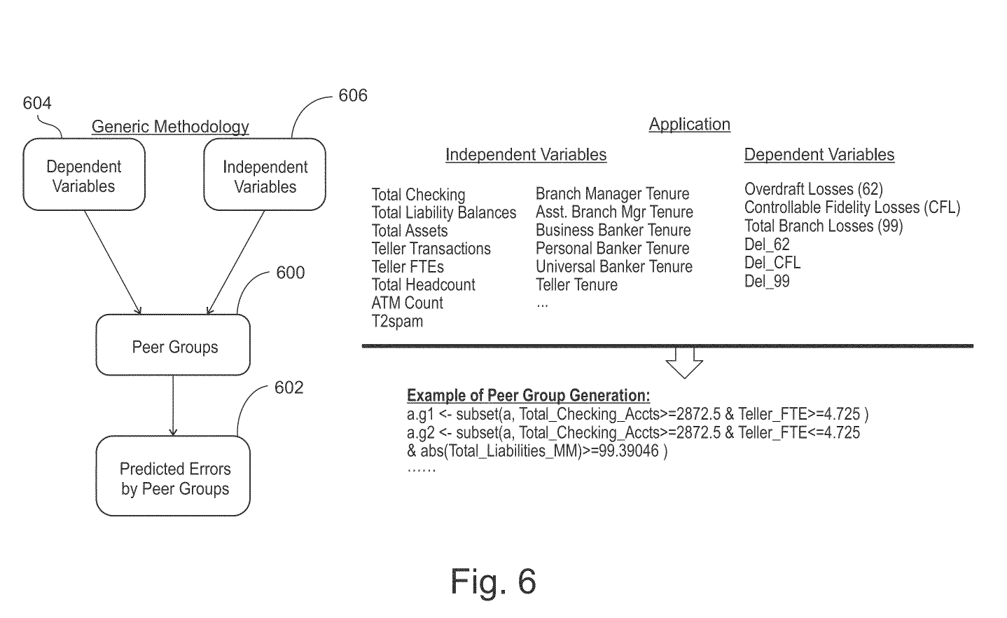

FIG. 6 is a diagrammatic flow chart representation of an example of dynamic segmentation to create peer groups for embodiments of the invention. A purpose of dynamic segmentation may be, for example, to create peer groups within which to evaluate abnormal behaviors of a branch. The segmentation methodology for embodiments of the invention may employ a multivariate regression tree which can be used to dynamically create a number of branch peer groups 600 based, for example, on loss characteristics. Any number of such branch peer groups 600 may be created based on loss characteristics, and it is to be understood that the number of such branch peer groups 600 created is not limiting.

Referring to FIG. 6, a predicted error 602 that reflects outlier behaviors of the branch against its own peer group may be computed as equal, for example, to branch loss minus expected branch loss given the profile of the particular branch within its peer group. As noted, in performing the dynamic segmentation, multivariate regression trees may be applied. Multivariate dependent variables 604 rather than a single dependent variable are used and may include, for example, overdraft losses, controllable fidelity losses, and total branch losses. Multivariate independent variables 606 may likewise be used. Such independent variables may include, for example, total checking, liability balances, and assets; teller transactions and teller full-time equivalents; total headcount and ATM count; tenures of branch and assistant branch manager, business, personal and universal banker, and teller; and T2spam score. Further, one or more independent variables 606 may be added and one or more of the included independent variables may be omitted in the segmentation. Thus, the segmentation process for embodiments of the invention is both dynamic and adaptable.

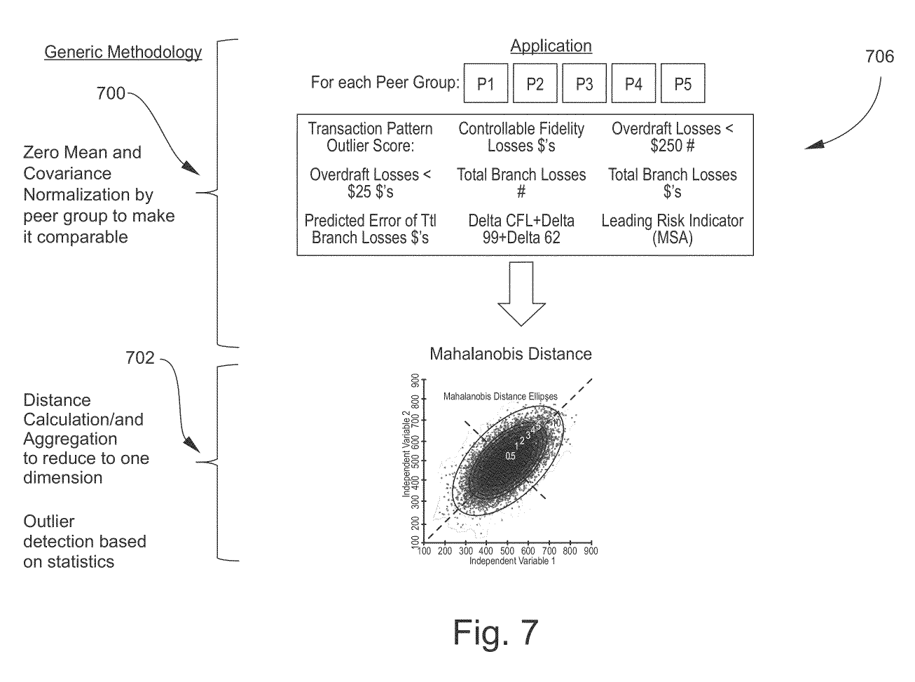

FIG. 7 is a diagrammatic flow chart overview representation of an example of the methodology for normalization 700, and distance calculation and aggregation 702 for embodiments of the invention. An object of such methodology may be to normalize and aggregate risks and generate a single, comprehensive branch-at-risk score. Referring to FIG. 7, assuming, for example, five peer groups, P1 through P5, created by segmentation based on loss characteristics, normalization 700 may involve the use of zero mean and covariance adjustment to determine off-scale impact.

In the normalization process 700, all of the risk components 706 in FIG. 7, may be normalized using zero mean and covariance normalization for all components by peer group. Aggregation of risks 702 may be performed using, for example, Mahalanobis distance calculation 702 for each branch from its peer group norm to aggregate the multi-dimensional risks. In addition, comparisons may be made using outlier scores with a cut-off value to identify outliers for practical usage.

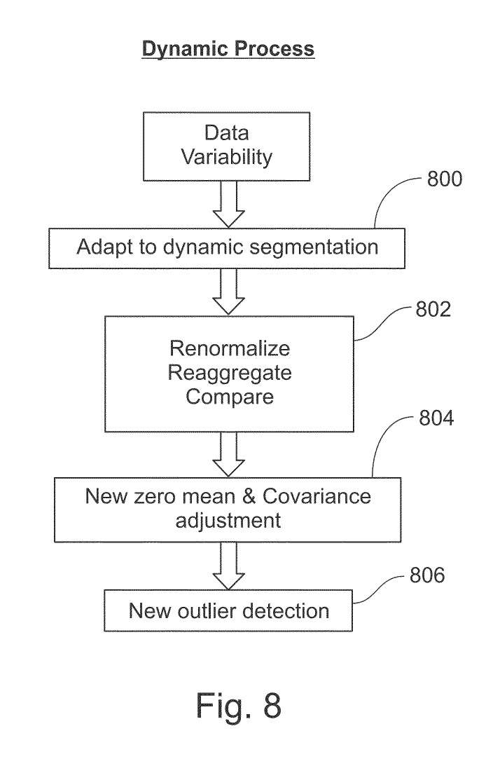

FIG. 8 is a diagrammatic flow chart overview representation of an example of the dynamic nature of the process using re-evaluation and re-normalization for embodiments of the invention. The branch-at-risk model for embodiments of the invention may include re-evaluation and re-normalization and thus adapts to changing data sources or data sets and is capable of generating a valid score even when variables or data are missing or newly added. As an outcome of the dynamic aspect of the model for embodiments of the invention, a new type of fraud or outlier behaviors may be discovered as a result of detection of abnormal behaviors. The process is dynamic in adjusting to updated datasets 800, for example, with new transaction information and changing data sources. Addition of a new data source may result, for example, in a new peer group, re-normalization and re-aggregation and comparison 802, as well as new zero mean and covariance adjustment 804. Further, when fraud behavior changes over time and/or a new type of fraud arises, it may be revealed as a new outlier 806 in the re-normalization process.

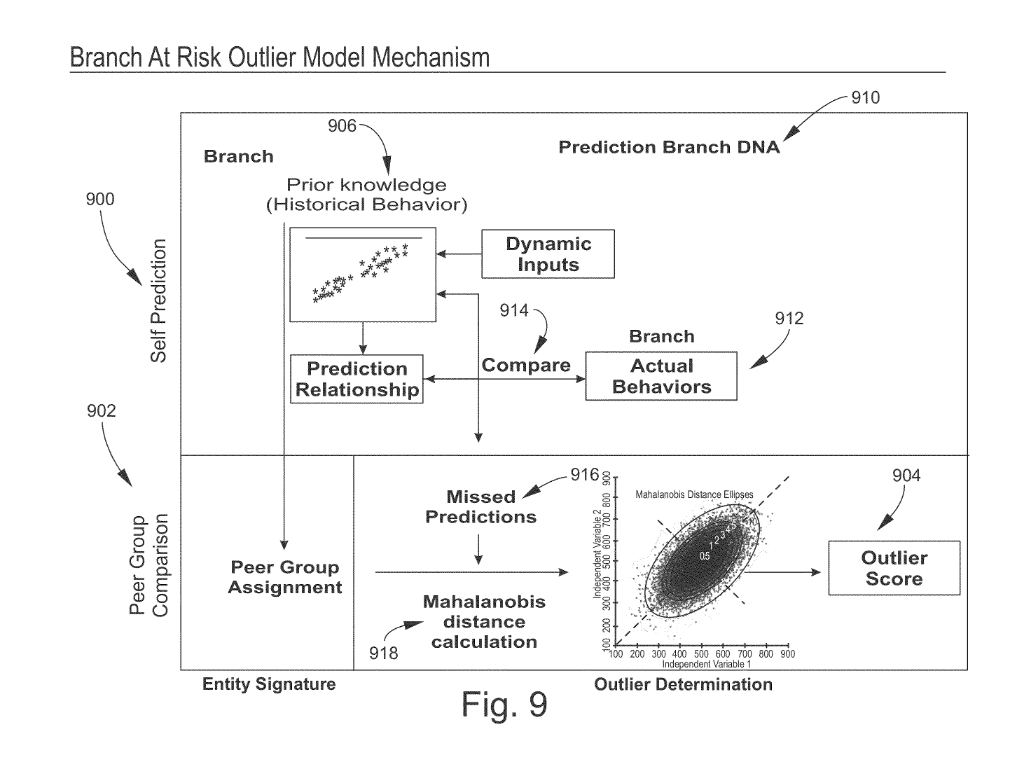

FIG. 9 is a diagrammatic flow chart representation of an example of the branch-at-risk outlier model mechanism and visualization of the modeling process and key components in the model for embodiments of the invention. Referring to FIG. 9, the branch-at-risk outlier model mechanism includes, for example, the dynamic data sourcing process, normalization based on peer groups and self-predictions, aggregation of different operational risks, and creation of a single quantitative branch-at-risk score.

As previously noted, the process may involve a comparison of the actual behaviors of an entity against its own expected behaviors, or self-prediction 900, and then against the behaviors of its peer group, or peer group comparison 902. Outlier behaviors 904 may be discovered as a result of detection of abnormal behaviors. In the process of self-prediction 900, prior knowledge 906 may represent, for example, current profile information for each branch. At a succeeding time, new knowledge may be acquired and the current knowledge updated. Based on the updated knowledge, the process may yield a predicted branch DNA 910. Actual behaviors 912 may relate to available information about the branches. A compare step 914 may be a learning process that involves a feedback of new information as it becomes available. Missed predictions 916 may relate to missed expectations for a particular branch. In the process of peer group comparison 902 missed expectations for a particular branch are compared and aggregated against its peer group and may result in its identification as an outlier from a behavior perspective and therefore a branch at risk. As also previously noted, the outlier score 904 may be based on a Mahalanobis distance calculation 918.

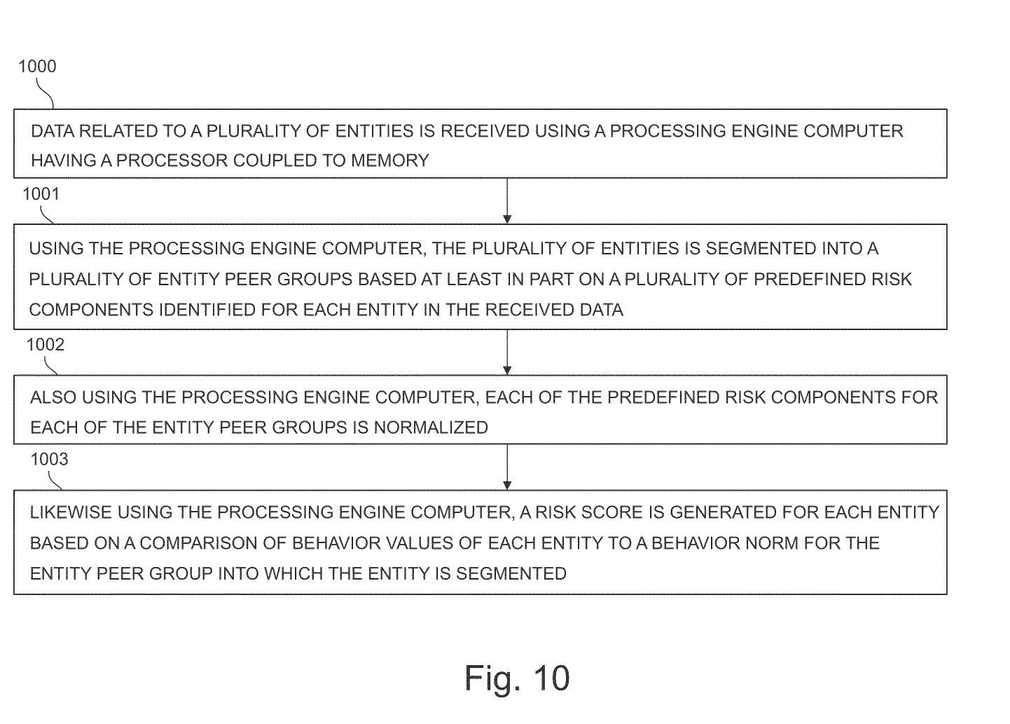

FIG. 10 is a schematic flow chart that illustrates an overview example of the process of assessing behavior\, such as fraud and risk, in financial entities and transactions for embodiments of the invention. Referring to FIG. 10, at 1000, data related to a plurality of entities may be received using a processing engine computer having a processor coupled to memory. At 1001, using the processing engine computer, the plurality of entities may be segmented into a plurality of entity peer groups based at least in part on a plurality of behavior components identified for each entity in the received data. At 1002, also using the processing engine computer, all of the behavior components for each of the entities may be normalized. At 1003, a behavior score may be generated for each entity based on a comparison of behavior values of each entity to a behavior norm for the entity peer group into which the entity is segmented.

It is to be understood that embodiments of the invention may be implemented as processes of a computer program product, each process of which is operable on one or more processors either alone on a single physical platform, such as a personal computer, or across a plurality of platforms, such as a system or network, including networks such as the Internet, an intranet, a Wide Area Network (WAN), a Local Area Network (LAN), a cellular network, or any other suitable network. Embodiments of the invention may employ client devices that may each comprise a computer-readable medium, including but not limited to, Random Access Memory (RAM) coupled to a processor. The processor may execute computer-executable program instructions stored in memory. Such processors may include, but are not limited to, a microprocessor, an Application Specific Integrated Circuit (ASIC), and or state machines. Such processors may comprise, or may be in communication with, media, such as computer-readable media, which stores instructions that, when executed by the processor, cause the processor to perform one or more of the steps described herein.

It is also to be understood that such computer-readable media may include, but are not limited to, electronic, optical, magnetic, RFID, or other storage or transmission device capable of providing a processor with computer-readable instructions. Other examples of suitable media include, but are not limited to, CD-ROM, DVD, magnetic disk, memory chip, ROM, RAM, ASIC, a configured processor, optical media, magnetic media, or any other suitable medium from which a computer processor can read instructions. Embodiments of the invention may employ other forms of such computer-readable media to transmit or carry instructions to a computer, including a router, private or public network, or other transmission device or channel, both wired or wireless. Such instructions may comprise code from any suitable computer programming language including, without limitation, C, C++, C#, Visual Basic, Java, Python, Perl, and JavaScript.

It is to be further understood that client devices that may be employed by embodiments of the invention may also comprise a number of external or internal devices, such as a mouse, a CD-ROM, DVD, keyboard, display, or other input or output devices. In general such client devices may be any suitable type of processor-based platform that is connected to a network and that interacts with one or more application programs and may operate on any suitable operating system. Server devices may also be coupled to the network and, similarly to client devices, such server devices may comprise a processor coupled to a computer-readable medium, such as a RAM. Such server devices, which may be a single computer system, may also be implemented as a network of computer processors. Examples of such server devices are servers, mainframe computers, networked computers, a processor-based device, and similar types of systems and devices.

1. A method for assessing financial institution branch behavior, comprising:
receiving, using a processing engine computer having a processor coupled to memory, data related to a plurality of branches of a financial institution;
segmenting, using the processing engine computer, the plurality of branches into a plurality of branch peer groups based at least in part on a plurality of branch operational risk behavior components consisting at least in part of observed branch losses identified for each branch of the financial institution in the received data;
normalizing, using the processing engine computer, each of the branch operational risk behavior components for each of the branch peer groups; and
generating, using the processing engine computer, a branch operational risk behavior score for each branch of the financial institution based on a comparison of operational risk behavior values of each branch of the financial institution to a branch operational risk behavior norm for the branch peer group into which the branch is segmented.

2-4. (canceled)

5. The method of claim 1, wherein said plurality of branch behavior components identified for each branch in the received data further comprises pre-defined abnormal branch transaction behavior identified in the data.

6. The method of claim 1, wherein segmenting the plurality of branches further comprises determining underlying clustering of branches based upon transaction patterns identified in the data.

7. The method of claim 1, wherein segmenting the plurality of branches further comprises creating transaction features identified in the data at an account level for each branch.

8. The method of claim 7, wherein creating transaction features at an account level further comprises creating transaction features at an account level based at least on part on transaction types, transaction amounts, transaction frequency, and transaction times identified in the data.

9. The method of claim 7, wherein creating transaction features further comprises aggregating transaction features for each branch based at least in part on feature frequencies identified in the data.

10. The method of claim 7, wherein creating transaction features further comprises representing the transaction features by numeric values.

11. The method of claim 10, wherein representing the transaction features by numeric values further comprises generating vectors for each branch based at least in part on said numeric values.

12. The method of claim 11, wherein generating the vectors for each branch further comprises integrating text mining with clustering to establish the transaction features through feature creation and vectorization.

13. The method of claim 7, wherein creating transaction features at an account level further comprises aggregating the transaction features into a branch level for each branch.

14. The method of claim 1, wherein segmenting the plurality of branches into a plurality of branch peer groups further comprises segmenting the plurality of branches into the plurality of branch peer groups based on loss characteristics identified in the data.

15. The method of claim 14, wherein segmenting the plurality of branches into the plurality of branch peer groups based on loss characteristics further comprises generating a predicted error that reflects outlier behaviors of at least one branch against the branch's peer group.

16. The method of claim 1, wherein segmenting the plurality of branches into a plurality of branch peer groups further comprises determining optimal branch peer group segments using multivariate regression decision tree analysis.

17. The method of claim 1, wherein normalizing each of the branch behavior components further comprises normalizing the branch behavior components using zero mean and covariance normalization by branch peer group.

18. The method of claim 1, wherein normalizing each of the branch behavior components further comprises normalizing, aggregating and summing a plurality of different attribute sets having different scales.

19. The method of claim 1, wherein normalizing each of the branch behavior components further comprises employing multivariate normalization to account for multi-collinearity among different attribute sets.

20. The method of claim 1, wherein generating the branch behavior score further comprises generating a quantitative branch behavior score that reflects an extent to which each branch presents behaviors consistent with operational risk or fraud.

21. The method of claim 1, wherein generating the branch behavior score further comprises comparing actual branch behaviors of each branch against the branch's expected behaviors and against branch behaviors of a segment norm for the branch's segment.

22. The method of claim 1, further comprising receiving new data related to the plurality of branches, re-segmenting the plurality of branches based at least in part the plurality of branch behavior components identified in the new data, re-normalizing each of the branch behavior components, and generating a new branch behavior score for each entity branch.

23. The method of claim 1, further comprising iteratively receiving new data related to the plurality of branches, iteratively re-segmenting the plurality of branches based at least in part a plurality of new branch behavior components identified in the new data, iteratively re-normalizing each of the branch behavior components, and iteratively generating a new branch behavior score for each branch.

24. An apparatus for assessing financial institution branch behavior, comprising:
a processing engine computer having a processor coupled to memory, the processor being programmed for:
receiving data related to a plurality of branches of a financial institution;
segmenting the plurality of branches into a plurality of branch peer groups based at least in part on a plurality of branch operational risk behavior components consisting at least in part of observed branch losses identified for each branch of the financial institution in the received data;
normalizing each of the branch behavior operational risk components for each of the branch peer groups; and
generating a branch operational risk behavior score for each branch of the financial institution based on a comparison of operational risk behavior values of each branch of the financial institution to a branch operational risk behavior norm for the branch peer group into which the branch is segmented.

25. A method for assessing entity financial institution branch behavior, comprising:
receiving, using a processing engine computer having a processor coupled to memory, data related to a plurality of branches of a financial institution;
segmenting, using the processing engine computer, the plurality of branches into a plurality of branch peer groups based at least in part on a plurality of branch operational risk behavior components identified for each branch in the received data;
normalizing, using the processing engine computer, each of the operational risk behavior components for each of the branch peer groups;
generating, using the processing engine computer, a branch operational risk behavior score for at least one of the plurality of branches of the financial institution based on a comparison of an operational risk behavior value of the at least one of the plurality of branches to a behavior norm for the branch peer group into which the at least one of the plurality of branches is segmented; and
receiving, using the processing engine computer, updated data related to the plurality of branches at a succeeding time, re-segmenting the plurality of branch peer groups based at least in part on a plurality of new branch operational risk behavior components identified in the updated data, re-normalizing each of the branch operational risk behavior components, and generating an updated behavior score for the at least one of the plurality of branches based on a comparison of an updated branch operational risk behavior value for the at least one of the plurality of branches to an updated behavior norm for the re-segmented branch peer group into which the at least one of the plurality of branches is segmented.

26. A method for assessing financial institution branch behavior, comprising:
receiving, using a processing engine computer having a processor coupled to memory, data related to operational risk behavior patterns of a plurality of branches of a financial institution;
determining, using the processing engine computer, numeric operational risk behavior pattern values for each of the plurality of branches of the financial institution based on the received data;
segmenting, using the processing engine computer, the plurality of branches of the financial institution into a plurality of branch clusters based at least in part on the numeric operational risk behavior pattern values determined for each of the plurality of branches of the financial institution;
vectorizing, using the processing engine computer, the numeric operational risk behavior pattern value determined for at least one of the plurality of branches of the financial institution; and
generating, using the processing engine computer, a branch operational risk behavior score for the at least one of the plurality of branches of the financial institution based on a dissimilarity distance between the numeric operational risk behavior pattern vector for the at least one of the plurality of branches of the financial institution and a branch operational risk behavior norm for the branch cluster into which the at least one of the plurality of branches of the financial institution is segmented.

27. A method for assessing financial institution branch behavior, comprising:
receiving, using a processing engine computer having a processor coupled to memory, data consisting at least in part of multivariate dependent variable data and multivariate independent variable data related to operational risk behavior of a plurality of branches of a financial institution;
identifying, using the processor engine computer, operational risk behavior patterns for each of the plurality of branches based at least on part on multivariate regression tree analysis of the multivariate dependent variable data and the multivariate independent variable data;
segmenting, using the processing engine computer, the plurality of branches into a plurality of branch peer groups based at least in part on the identified branch operational risk behavior patterns;
normalizing, using the processing engine computer, the operational risk behavior patterns for each of the branch peer groups; and
generating, using the processing engine computer, a branch operational risk behavior score for at least one of the plurality of branches based on a comparison of branch operational risk behavior patterns of the at least one of the plurality of branches to a branch operational risk behavior norm for the branch peer group into which the at least one of the plurality of branches is segmented.
